(19) United States
(12) Patent Application Publication
(10) Pub. No.: US 2008/0056495 A1
(43) Pub. Date: Mar. 6, 2008

(54) Wireless communication system, vehicle unit, roadside unit and server

(75) Inventors: Osamu Eguchi, Kuwana-city (JP); Shouichirou Hanai, Anjo-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/899,357

(22) Filed: Sep. 4, 2007

(30) Foreign Application Priority Data
Sep. 5, 2006 (JP) 2006-240491
Nov. 20, 2006 (JP) 2006-313377

(51) Int. Cl. H04L 9/32; H04K 1/00

(52) U.S. Cl. 380/270; 705/50

(57) ABSTRACT

A wireless communication system provides a decryption module for decrypting card information on a roadside unit for information registration and a roadside unit for toll collection instead of providing the decryption module on a vehicle unit. In this manner, the wireless communication system can accommodate an IC card that uses a new encryption method more easily relative to a conventional wireless communication system, because the roadside units are smaller in number in comparison to the vehicle units at the time of system operation with greater allowance for demand for space efficiency and cost reduction.

### CROSSREFERENCE TO RELATED APPLICATION

This application is based on and claims the benefit of priority of Japanese Patent Applications No. 2006-240491 filed on Sep. 5, 2006, and No. 2006-313377 filed on Nov. 20, 2006, the disclosure of which is incorporated herein by reference.

### FIELD OF THE DISCLOSURE

The present disclosure generally relates to a wireless communication system and apparatus for wirelessly collecting a toll.

### BACKGROUND INFORMATION

An ETC system (the Electronic Toll Collection System) is known as one of the wireless communication systems performing receipt such as a toll through radio. This ETC system is the system which automatically performs toll payment by employing a wireless communication between a roadside unit at a toll gate and a vehicle unit on a vehicle, thereby allowing the vehicle to pass through the toll gate without stopping.

As for the ETC system, the vehicle unit of the system is currently in the course of utilization for payment in a fast food shop, of parking fee in an amusement park or the like, and a wide variety of implementations is now being expected.

FIG. 17A is a block diagram showing a constitution example of an in-vehicle unit in a conventional ETC system. The in-vehicle unit 160 equips a DSRC unit 162, an HMI 163, an ETC-SAM 164 and an integrated circuit (IC) card interface 165 as well as a control unit 166 having a radio antenna 161 as shown in the figure. In this case, “SAM” generally stands for Secure Application Module in the art.

A radio antenna 161 is an antenna for Dedicated Short Range Communication. The DSRC unit 162 performs transmission and reception of information by DSRC through the radio antenna 161.

The HMI 163 is a unit offering an interface (i.e., Human Machine Interface) for communication between a human being and a device. More practically, the HMI 163 is constituted from an operation button, LEDs and the like.

The ETC-SAM 164 equips a vehicle unit v-SAM 164a for the in-vehicle device and a card v-SAM 164b for the IC card. The vehicle unit v-SAM 164a for the in-vehicle device performs encrypting/decrypting (e.g., encryption/decryption) of information communication with the roadside device as well as encrypting/decrypting of vehicle device information (a management number, a form registration number, the number of a vehicle and the like). On the other hand, the v-SAM 164b for IC card performs encrypting/decrypting of card information (a card number, expiration date, name information, a card issuer number, a card type, money balance, use history information and the like).

The IC card interface 165 is an interface to perform communication with the IC card 167, and the is used to read out stored information of the IC card 167. In this case, the IC card interface 165 is controlled by the v-SAM 164b.

The control unit 166 consists of a central processing unit, a ROM, a RAM, an I/O and the like, and controls the DSRC unit 162, the HMI 163 and the ETC-SAM 164 in a unified manner.

FIG. 17B is a block diagram showing a constitution example of a roadside unit in the conventional ETC system. The roadside unit 180 equips a DSRC unit 182, a road SAM 183, a communication interface (I/F) 184 and a control part 185 with a radio antenna 181 as shown in the figure.

The radio antenna 181 is an antenna for use in DSRC. The DSRC unit 182 performs transmission and reception of information by DSRC through the radio antenna 181.

The road SAM 183 is a unit having function of decrypting encrypted information sent from the in-vehicle unit 160 and function of encrypting information to be sent to the in-vehicle unit 160.

The communication interface 184 is a wired interface to communicate with an information center or a toll gate computer. In this case, the information center is a computer having function to manage the whole ETC system, and the toll gate computer is a computer having function to perform a process for toll collection.

The control unit 185 consists of a central processing unit (CPU), a ROM, a RAM, an I/O and the like, and controls the DSRC unit 182, the road SAM 183 and the communication interface 184 in a unified manner.

FIG. 18 is a sequence chart showing an example of a data processing sequence between the in-vehicle device 160 (the control unit 166, the ETC-SAM 164), the roadside unit 180 and the IC card in the conventional ETC system.

When the IC card 167 is set to the in-vehicle device 160; the control unit 166 sends to ETC-SAM 164 a card information read request (S905). Upon receiving the card information read request on the ETC-SAM 164, the card v-SAM164b sends to the IC card a card information retrieval request through the IC card interface 165 (S906), and retrieves the encrypted card information from the IC card (S910). Then, the card v-SAM164b decrypts the encrypted card information to pass it to the control unit 166 (S915).

The control unit 166 stores the decrypted card information after reception of the information, and performs communication with the roadside equipment 180 as long as the IC card is set in the vehicle unit 160.

Then, as the encrypted information is passed from the roadside unit 180 to the vehicle unit 160 (S620), the control unit 166 in the vehicle unit 160 passes the information to the ETC-SAM 164 for decryption (S925).

As the ETC-SAM 164 receives the encrypted information, the ETC-SAM 164 decrypts the information with the vehicle unit v-SAM 164a, and passes it to the control unit 166 (S930). Then, the control unit 166 receives the decrypted information, and executes a predetermined process that utilizes the received information.

Further, when the control unit 166 of the in-vehicle unit 160 is required to send the card information and the like in the storage to the roadside equipment 180 after encryption, the control unit 166 passes the information to the ETC-SAM 164 for encryption (S935).

The ETC-SAM 164 encrypts the received information with the vehicle unit v-SAM 164a upon receiving the information, and passes it to the control unit 166 (S940).

The control part 166 transmits the encrypted information to the roadside unit 180 upon receiving the information (S945). The above-described encryption/decryption scheme is disclosed in Japanese Patent Laid-Open No. JP-A-2004-62468 (This document is also published as US patent document U.S. Pat. No. 6,920,379).

As described above, the encrypted card information retrieved from the IC card is used after decryption with the card v-SAM164b in the ETC-SAM 164 in the conventional ETC system. In other words, the card v-SAM164b is indispensable to the in-vehicle unit 160.

Therefore, in dealing with an application that is different from the ETC system, the in-vehicle unit is required to have a different module that is equivalent to the vehicle v-SAM164b when the application uses a different encryption method to communicates with an IC card.

The above-described situation becomes a problem when various applications are realized in the ETC system. In other words, the in-vehicle unit increases its volume and complicates its structure as well as increasing the difficulty of adding applications after distribution of the in-vehicle unit in the market if different modules are added thereon.

Further, because the IC card is required to be inserted in the in-vehicle unit when the in-vehicle unit communicates with the roadside unit, the user is obliged to re-insert the IC card in the in-vehicle unit after pulling the IC card at, for example, a service area in an expressway or the like if the toll is collected at an exit from the expressway.

### SUMMARY OF THE DISCLOSURE

In view of the above and other problems, the present disclosure provides a wireless communication system that is convenient for a user of a vehicle unit and a system administrator.

The wireless communication system in the present disclosure includes a vehicle side controller that transmits encrypted information retrieved from an external memory medium (e.g., an IC card, a memory card or the like) through an interface unit to a first roadside unit through a vehicle side wireless communication unit, and a controller in the first roadside unit transmits the encrypted information that is received from the vehicle unit through the wireless communication unit in the first roadside unit back to the vehicle unit through the wireless communication unit in the first roadside unit after verifying authenticity of a content of the encrypted information by decrypting it with a security unit in the first roadside unit.

Then, the controller in the vehicle unit stores in a memory unit the encrypted information that is received from the first roadside unit through the vehicle side wireless communication unit, and the controller in the vehicle unit transmits the encrypted information that is stored in the memory unit through the vehicle side wireless communication unit to a second roadside unit thereafter upon having a transmission request for the encrypted information that is stored in the external memory medium from the second roadside unit. Then, a controller in the second roadside unit puts the encrypted information that is received by requesting it to the vehicle unit for use by a predetermined application after decrypting it with a security unit in the second roadside unit. In this case, the application implies an application system for collecting a toll or the like such as a toll collection system in an expressway (e.g., so-called ETC system in Japan), a parking fee collection system in a time-charged parking space or the like.

The wireless communication system described above is not necessarily in a communicable condition in terms of communication with the external memory medium when the vehicle unit communicates with the roadside unit. Therefore, for example, when the user uses a toll collection system that collects a toll at a toll booth of an exit from a toll road, the user is not obliged to re-insert the IC card into an IC card slot before passing through a toll booth after pulling the IC card out of the IC card slot at a service area or the like. Therefore, a user operation for inserting the IC card into the slot is saved in the situation described above.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a wireless communication system in a first embodiment of the present disclosure;

FIG. 2 shows a block diagram of a vehicle unit in the first embodiment of the present disclosure;

FIGS. 3A and 3B show block diagrams of a registration unit and a toll unit in the first embodiment of the present disclosure;

FIG. 4 shows a sequence chart of a card information registration process to the vehicle unit in the first embodiment of the present disclosure;

FIG. 5 shows a sequence chart of a toll collection process in the first embodiment of the present disclosure;

FIG. 6 shows a sequence chart of a history storage process on an IC card in the first embodiment of the present disclosure;

FIG. 7 shows a block diagram of a wireless communication system in a second embodiment of the present disclosure;

FIGS. 8A and 8B show block diagrams of the registration unit and the toll unit in the second embodiment of the present disclosure;

FIG. 9 shows a sequence chart of a card information registration process to the vehicle unit in the second embodiment of the present disclosure;

FIG. 10 shows a sequence chart of a toll collection process in the second embodiment of the present disclosure;

FIG. 11 shows a block diagram of a wireless communication system in a third embodiment of the present disclosure;

FIGS. 12A and 12B show block diagrams of the vehicle unit and the cellular phone in the third embodiment of the present disclosure;

FIG. 13 shows a block diagram of a card center server in the third embodiment of the present disclosure;

FIG. 14 shows a sequence chart of a card ID registration process for the vehicle unit in the third embodiment of the present disclosure;

FIG. 15 shows a flowchart of the card ID registration process in the vehicle unit in the third embodiment of the present disclosure;

FIG. 16 shows a flowchart of the card ID registration process in the card center server in the third embodiment of the present disclosure;

FIGS. 17A and 17B show block diagrams of the vehicle unit and a roadside unit in a conventional system; and

FIG. 18 shows a sequence chart of an encryption/decryption process in the conventional system.

### DETAILED DESCRIPTION

Embodiments of the present disclosure is described with reference to the accompanying drawings. In this case, the present disclosure of an invention is not limited to the embodiments in the following, but takes various forms as far as they belong to an art of the invention.

### First Embodiment

[Explanation of Configuration]

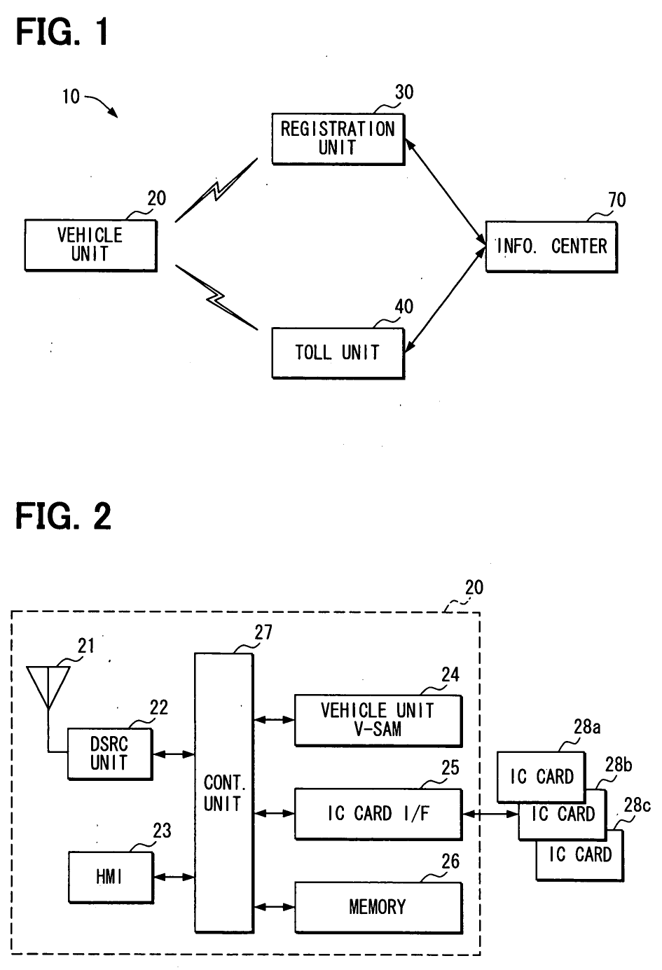

FIG. 1 is a block diagram showing a constitution of a wireless communication system 10 in a first embodiment. The wireless communication system 10 equips the vehicle unit 20 carried by a vehicle, the registration unit 30 that is placed on a roadside in a service area, a parking area, a gas station and the like, a toll unit 40 that is placed on a roadside at an exit/entrance of a toll road, the parking area and the like and an information centre 70. In addition, FIG. 1 shows only one of the vehicle unit 20, the registration unit 30 and toll unit 40 in the drawing, plural pieces of respective units are used in an actual system. Further, the registration unit 30 may be placed at an entrance of the toll road or the like with a distinguishing sign attached thereon to be clearly distinguishable from the toll unit 40 by the user.

Next, the details of the vehicle unit 20 are explained by using a block diagram in FIG. 2. The vehicle unit 20 equips the radio antenna 21, a DSRC unit 22, an HMI 23, a vehicle unit v-SAM 24, an integrated circuit (IC) card interface (I/F) 25, a memory 26 and a control unit 27.

The radio antenna 21 is used for Dedicated Short Range Communication (DSRC) that provides a wireless communication for narrow area communication.

The DSRC unit 22 performs transmission and reception of information through the radio antenna 21 by DSRC.

The HMI 23 is an interface unit offering Human Machine Interface for communication between a human being and a device. More practically, the interface consists of an operation button and/or LEDs.

The vehicle unit v-SAM 24 performs encryption and decryption of information exchanged with the registration unit 30 and the toll unit 40 as well as encryption/decryption of vehicle unit information (i.e., a management number, a form registration number, the number of a vehicle and the like).

The IC card interface 25 is an interface to communicate with IC cards 28a, 28b, 28c, and retrieves information stored by the IC cards 28a, 28b, 28c as well as stores information in those IC cards 28a, 28b, 28c. In this case, it is assumed that the IC card interface 25 is an interface of a contactless type in the present embodiment, but it may be configured as a contact type interface. In this case, the IC cards 28a, 28b, 28c use respectively different encryption method for storing information.

The memory 26 consists of a device that does not require a memory content retaining operation for storing various information (e.g., a flash memory).

The control unit 27 consists of a central processing unit (CPU), a ROM, a RAM, an I/O, and the like, and controls the DSRC unit 22, the HMI 23, the vehicle unit v-SAM 24, the IC card interface 25 and the memory 26 are controlled in a unified manner.

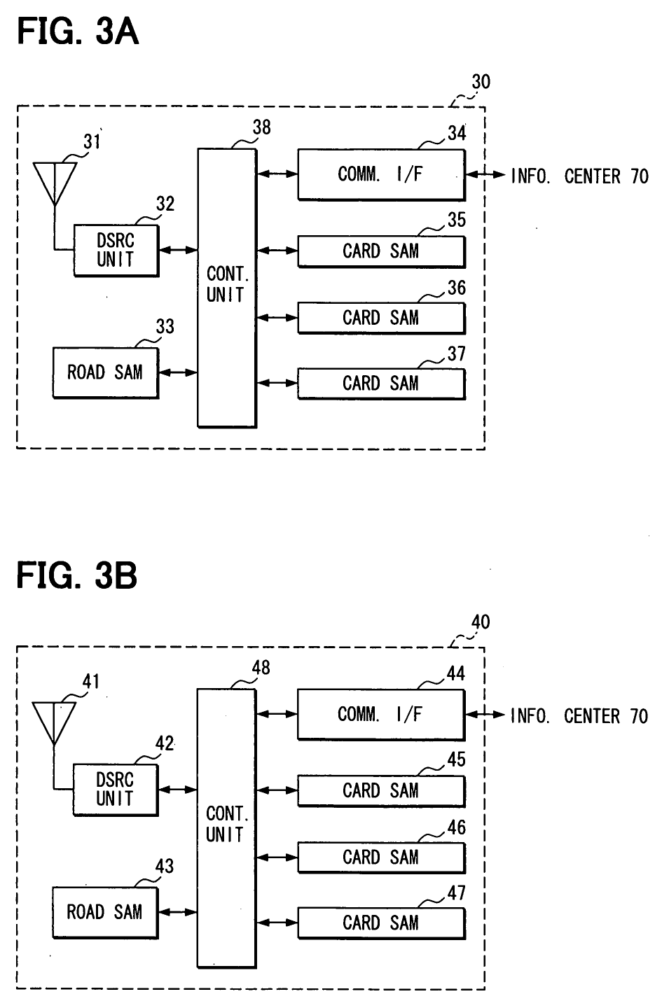

The details of the registration unit 30 registration are explained by using a block diagram in FIG. 3A in the following. The registration unit 30 equips the radio antenna 31, the DSRC unit 32, a road SAM 33, a communication interface 34, card SAMs 35, 36, 37 and a control unit 38.

The radio antenna 31 is an antenna for DSRC. The DSRC unit 32 uses the radio antenna 31 for performing transmission and reception of information by DSRC.

The road SAM 33 is a unit having function of encrypting information (except for card information) to be transmitted to the vehicle unit 20 as well as function of decrypting encrypted information received from the vehicle unit 20 (except for card information).

The communication interface 34 is an interface to communicate with the information center 70 through wired communication.

The card SAMs 35, 36, 37 are used to encrypt and decrypt information by an encryption method applied to the information that is stored in the IC cards 28a, 28b, 28c that respectively correspond to the card SAMs 35, 36, 37.

The control unit 38 is a unit including a central processing unit (CPU), a ROM, a RAM, an I/O and the like, and controls the DSRC unit 32, the road SAM 33, the communication interface 34 and the card SAMs 35, 36, 37 in a unified manner.

The details of the toll unit 40 are explained by using a block diagram in FIG. 3B in the following. The toll unit 40 equips a road SAM 43 and a communication interface 44 and card SAMs 45, 46, 47, a control unit 48 as well as the radio antenna 41 and the DSRC unit 42.

The radio antenna 41 is an antenna for DSRC. The DSRC unit 42 uses the radio antenna 41 for performing transmission and reception of information by DSRC.

The road SAM 43 is a unit having function of encrypting information (except for card information) to be transmitted to the vehicle unit 20 as well as function of decrypting encrypted information received from the vehicle unit 20 (except for card information).

The communication interface 44 is an interface to communicate with information center 70 through wired communication.

The card SAMs 45, 46, 47 are used to encrypt and decrypt information by an encryption method applied to the information that is stored in the IC cards 28a, 28b, 28c that respectively correspond to the card SAMs 35, 36, 37. In this case, the toll unit 40 in the present embodiment has three card SAMs (that means the toll unit 40 accommodates at least three different applications), but may only have one card SAM.

The control unit 48 is a unit including a central processing unit (CPU), a ROM, a RAM, an I/O and the like, and controls the DSRC unit 32, the road SAM 33, the communication interface 34 and the card SAMs 35, 36, 37 in a unified manner.

The information center 70 is explained in the following. The information center 70 consists of a well-known server apparatus, and has function of storing registration information sent from the registration unit 30, function of performing payment process based on payment information sent from the toll unit 40.

[Explanation of Operation]

The operation of the wireless communication system 10 is explained in the following.

(1) Card Information Registration Process

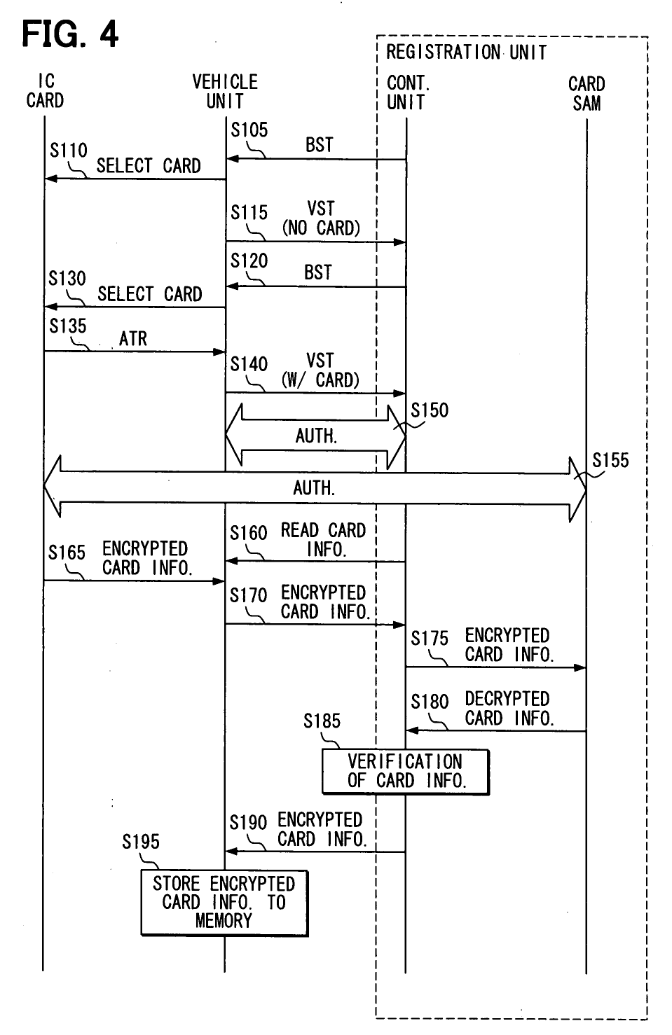

First, a process of card information registration regarding information stored in the IC card (one of the IC card 28a, 28b, 28c) to be registered in the vehicle unit 20 is described with reference to a sequence chart in FIG. 4. In this case, a well-known portion of DSRC protocol is omitted from the description for conciseness and brevity.

When the vehicle unit 20 receives a BST (Beacon Service Table) from the registration unit 30 after entering into a communication area of the registration unit 30 (S105), the vehicle unit 20 sends a response request (“SELECT CARD” in the drawing) for the IC card (S110). In this case, it is assumed that the IC card interface 25 of the vehicle unit 20 is impossible to communicate with the IC card (that is, it is assumed that the IC card is not in the proximity of the IC card interface 25).

If there is no response from the IC card before a predetermined time, the vehicle unit 20 sends to the registration unit 30 a VST (Vehicle Service Table) for informing the registration unit 30 of an absence of the IC card (S115).

When the vehicle unit 20 receives the BST again from the registration unit 30 after a predetermined interval (S120), the vehicle unit 20 sends the response request to the IC card (S130). If the IC card is able to communicate with the IC card interface 25 (if there is the IC card in a proximity of the IC card interface 25), a response to the vehicle unit 20 from the IC card (ATR in the figure) is sent (S135). Then, the vehicle unit 20 sends the VST to the registration unit 30 for informing the registration unit 30 of the presence of the IC card (S140).

Then, a mutual authentication is executed between the control unit 38 of the registration unit 30 and the vehicle unit 20 (S150), and the mutual authentication is executed between the card SAM of the registration unit 30 (one of the card SAMs 35, 36, 37 corresponding to the encryption method used for the present IC card) and the IC card (S155).

The card information read instruction is transmitted to the vehicle unit 20 from the control unit 38 of the registration unit 30 if the mutual authentication is normal (S160), and the vehicle unit 20 which received such instruction uses the IC card interface 25 to read the encrypted card information from the IC card (S165). In this case, the “card information” means a card number, an expiration date, name information, a card issuer number, a card type, the money balance, use history information and the like.

The vehicle unit 20 which has read the encrypted card information transmits the encrypted card information to the control unit 38 of the registration unit 30 (S170).

The control unit 38 of the registration unit 30 that received the encrypted card information passes the card information to one of the card SAMs corresponding to the card information (i.e., the card SAM that is capable of decrypting the card information) (S175). The card SAM which received the encrypted card information decrypts the encrypted card information, and passes the decrypted information to the control unit 38 (S180).

The control unit 38 which received the decrypted card information verifies the card information (S185). More practically, the control unit 38 verifies whether the decryption has been normal, whether the decrypted card information contains no discrepancy and the like. In this case, information may be retrieved from the information center 70 through the communication interface 34 for verification of the card information, or the card information may be transmitted to the information centre 70 for verification in the information centre 70.

If it is determined that the card information is normal, the registration unit 30 transmits the encrypted card information before decryption to vehicle unit 20 (S190). In this case, the reason why transmits the encrypted card information to the vehicle unit 20 is to prevent substitution of the card information or the like during the verification process and to securely store the encrypted card information that is verified to be normal in the vehicle unit 20.

The vehicle unit 20 which received the encrypted card information stores the received information in the memory 26 (S195). Thereafter, whenever transmission of the encrypted card information is requested by the toll unit 40, the vehicle unit 20 transmits the card information that is stored in the memory 26 to the toll unit 40, instead of retrieving the card information from the IC card, without determining that a communication with the IC card is possible.

(2) Toll Collection Process

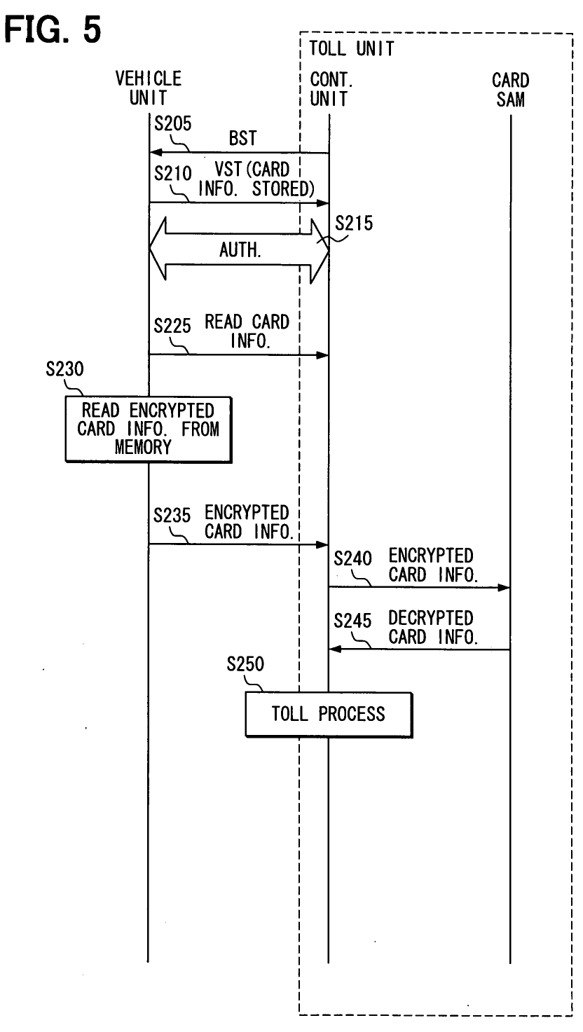

A process for collecting a toll by a communication between the vehicle unit 20 and the toll unit 40 is described next with reference to a sequence chart in FIG. 5. In this case, a well-known portion of DSRC protocol is omitted from the description for conciseness and brevity.

When the vehicle unit 20 receives the BST (Beacon Service Table) from the toll unit 40 after entering into a communication area (S205), the vehicle unit 20 determines whether the IC card information of the application corresponding to the toll unit 40 in the memory 26, and transmits the VST (Vehicle Service Table) to inform the toll unit 40 of the storage of the IC card information if the IC card information is stored in the toll unit 40 (S210).

Then, the mutual authentication is executed between the control unit 48 of toll unit 40 and the vehicle unit 20 (S215).

If the mutual authentication is normal, card information read instruction is transmitted to the vehicle unit 20 from the control unit 48 of toll unit 40 (S225). Then, the control unit 27 of the vehicle unit 20 reads the encrypted card information memorized in the memory 26 and corresponding to a specified application (S230). Then, the encrypted card information that has been read is transmitted to the toll unit 40 (S235).

The control unit 48 of the toll unit 40 that received the encrypted card information passes the card information to one of the card SAMs corresponding to the card information (the SAM that is capable of decrypting the card information) (S240). The card SAM which received the encrypted card information passes the card information to the control unit 48 after decrypting the encrypted card information (S245).

The control unit 48 which received the decrypted card information performs a toll collection process (S250). More practically, the control unit 48 performs a payment process by transmitting the card information through the communication interface 44, or performs a process that reduces an amount of the money balance in the card information stored in the memory 26 of the vehicle unit 20.

(3) History Information Write Process

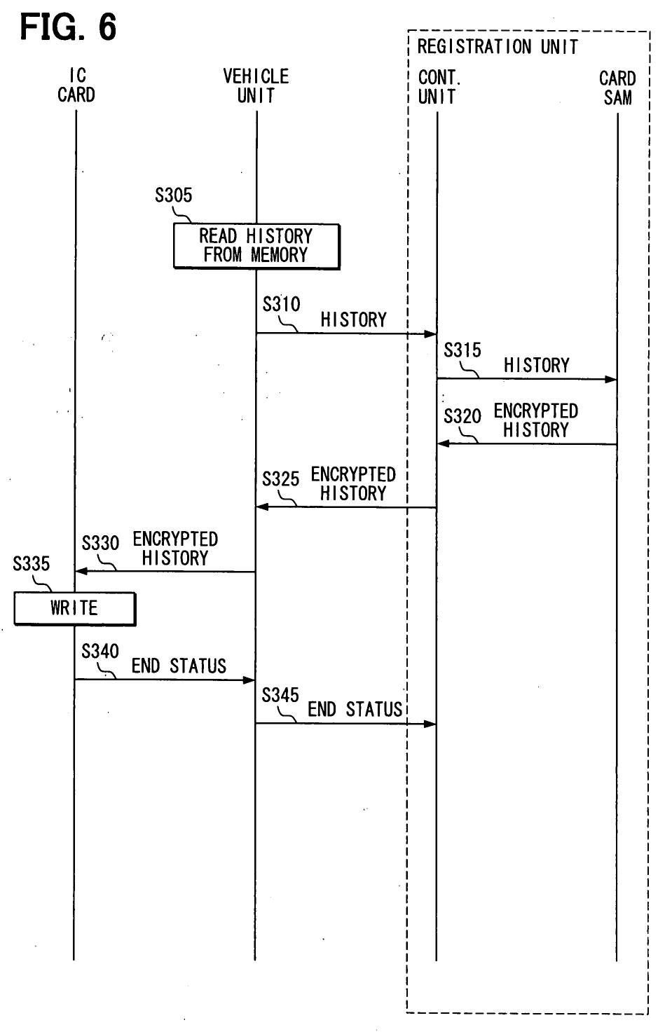

A process for storing use history information to the memory 26 of the vehicle unit 20 by a communication between the vehicle unit 20 and the registration unit 30 is described with reference to a sequence chart in FIG. 6. In this case, a well-known portion of DSRC protocol is omitted from the description for conciseness and brevity. In addition, an initial process (equivalent to steps S105 to S155 in FIG. 4) that is performed when the vehicle unit 20 enters into a communication area of the registration unit 30 is omitted from the description due to its similarity.

When the initial process is finished, the vehicle unit 20 retrieves based on an input from the HMI 23 history Information of a specific service from the memory 26 (S305).

Then, the vehicle unit 20 transmits the history information which has been read from the memory 26 to the registration unit 30 (S310).

The control unit 38 of the registration unit 30 that received the history information passes the history information to the card SAM (one of the card SAMs 35, 36, 37 corresponding to the encryption method for use with the IC card in association with the above service) (S315).

The card SAM which received the history information passes the encrypted history information to the control unit 38 (S320).

The control unit 38 of the registration unit 30 that received the encrypted history information transmits the history information to the vehicle unit 20 (S325).

The vehicle unit 20 which received the encrypted history information writes the history information to the IC card through the IC card interface 25 (S330, S335). When the vehicle unit 20 receives an end status that indicates that writing has finished from the IC card (S340), the end status indicating that the writing has finished is transmitted from the vehicle unit 20 to the registration unit 30 (S345).

### Effect of the Present Embodiment

Because a communicable condition to the IC card is not required at the time of the communication between the vehicle unit 20 and the toll unit 40, the user of the communication system 10 is free from bothering, prior to passing through the toll gate, to insert the IC card into the vehicle unit 20 after pulling it out from the vehicle unit 20 at the service area or the like.

Further, a decryption module for decrypting the encrypted card information is stored in the registration unit 30 and the toll unit 40, thereby enabling the communication system 10 to accommodate a new encryption method in an easier manner. (This is because the number of the roadside units [the registration units and the toll units] is smaller than the number of the vehicle units in the communication system in operation)

Furthermore, the information in the IC card is sent to the IC card after encryption (refer to FIG. 6), thereby enabling a reduction of the number of the modules used in the communication system for achieving the same result.

### Second Embodiment

Though the registration unit 30 in the first embodiment transmits to the vehicle unit 20 the card information before decryption after verifying the card information by decrypting when the card information is received from the vehicle unit 20 (S190), the card information which is used for verification after decryption may be transmitted to the vehicle unit after encryption by the road SAM 33. In other words, the vehicle unit 20 may store the card information in a condition which can be decrypted by the road SAM 43 without using the card SAMs 45, 46, 47 in the toll unit 40. The description in the second embodiment explains the above authentication scheme in detail.

[Explanation of Configuration]

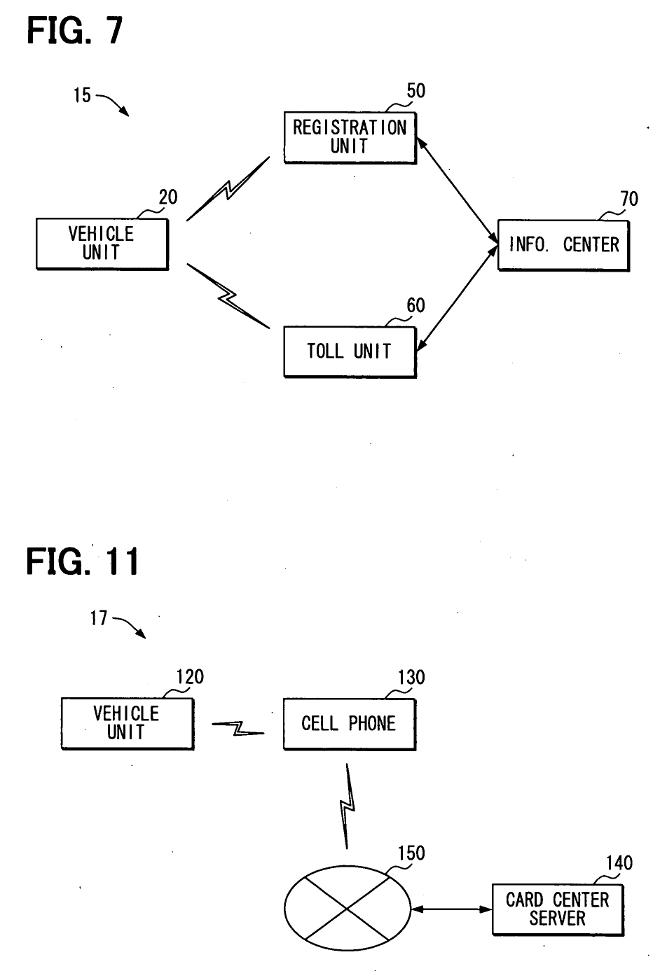

FIG. 7 is a block diagram showing a constitution of a wireless communication system 15 in the second embodiment. The wireless communication system 15 equips the vehicle unit 20 carried by a vehicle, a registration unit 50 that is placed on a roadside in a service area, a parking area, a gas station and the like, a toll unit 60 that is placed on a roadside at an exit/entrance of a toll road, the parking area and the like, and an information centre 70. Like parts have like numbers as used in the first embodiment, and description for the like parts is omitted. The information center 70 is described in the same manner. In addition, FIG. 7 shows only one of the vehicle unit 20, the registration unit 50 and the toll unit 60 in the drawing, plural pieces of respective units are used in an actual system. Further, the registration unit 50 may be placed at an entrance of the toll road or the like with a distinguishing sign attached thereon to be clearly distinguishable from the toll unit 60 by the user.

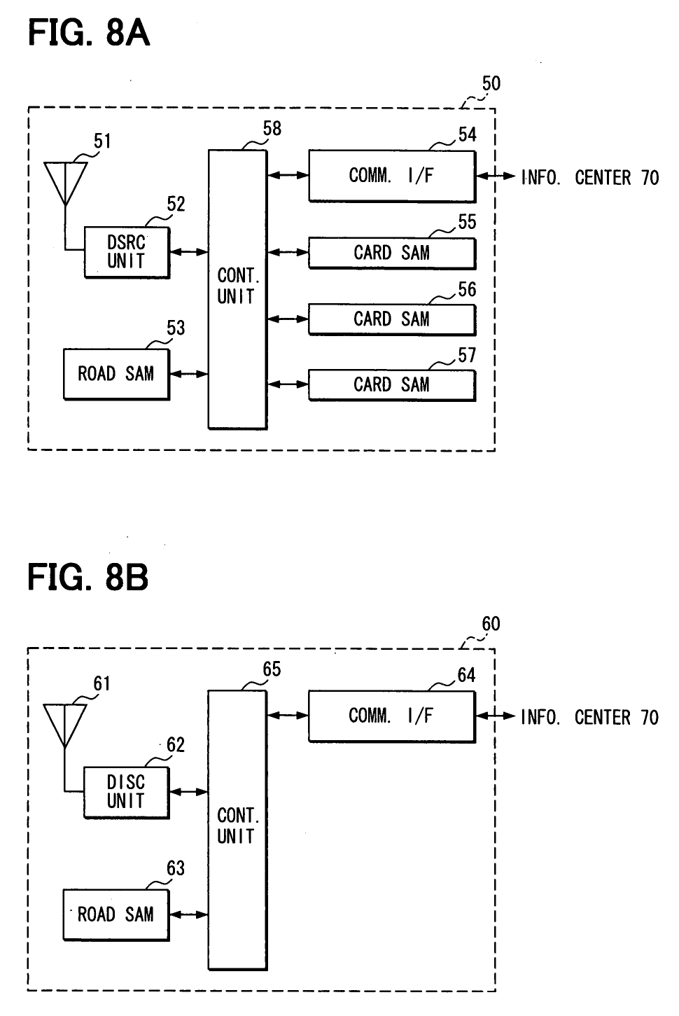

The details of the registration unit 50 are explained by using a block diagram in FIG. 8A.

The registration unit 50 equips a road SAM 53, a communication interface (I/F) 54, card SAMs 55, 56, 57 and a control unit 58 as well as a radio antenna 51 and a DSRC unit 52.

The radio antenna 51 is an antenna for use in DSRC. The DSRC unit 52 uses the radio antenna 51 for performing transmission and reception of the information by DSRC.

The road SAM 53 is a unit having function of encrypting information (including the card information) to be transmitted to the vehicle unit 20 as well as function of decrypting the encrypted information (except for the card information) which has been sent from the vehicle unit 20.

The communication interface 54 is an interface to communicate with the information center 70 through wired communication.

The CARD SAMS55, 56, 57 are used to encrypt and decrypt information by an encryption method applied to the information that is stored in the IC cards 28a, 28b, 28c that respectively correspond to the card SAMs 35, 36, 37.

The control unit 58 is a unit including a central processing unit (CPU), a ROM, a RAM, and an I/O and the like, and controls the DSRC unit 52, the road SAM 53, the communication interface 54 and the card SAMs 55, 56, 57 in a unified manner.

The details of the toll unit 60 are explained by using a block diagram in FIG. 8B in the following. The toll unit 60 equips a road SAM 63, a communication interface 64, a control unit 65 as well as the radio antenna 61 and the DSRC unit 62.

The radio antenna 61 is an antenna for DSRC. The DSRC unit 62 uses the radio antenna 61 for performing transmission and reception of information by DSRC.

The road SAM 63 is a unit having function of encrypting information (including card information) to be transmitted to the vehicle unit 20 as well as function of decrypting encrypted information received from the vehicle unit 20 (except for the card information). In addition, the encryption method used by the road SAM 63 is same as the encryption method used by the road SAM 53 of the registration unit 50. In other words, the information encrypted by the road SAM 53 of the registration unit 50 can be decrypted by the road SAM 63.

The communication interface (I/F) 64 is an interface to communicate with information center 70 through wired communication.

The control unit 65 consists of a central processing unit, ROM, an RAM, I/O, and it is the DSRC unit 62, the road SAM 63 and a unit controlling the communication interface 64 for unification.

The control unit 65 is a unit including a central processing unit (CPU), a ROM, a RAM, an I/O and the like, and controls the DSRC unit 62, the road SAM 63, the communication interface 64 in a unified manner.

[Explanation of Operation]

Operation of the wireless communication system 15 is explained in the following.

(1) Card Information Registration Process

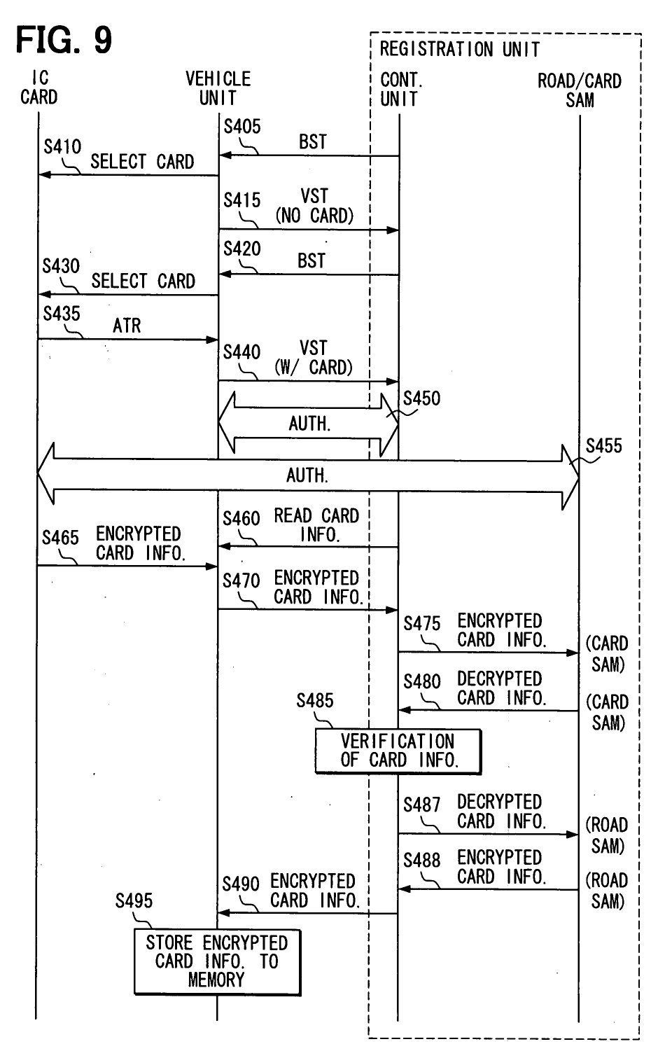

First, a process of card information registration regarding information stored in the IC card (one of the IC card 28a, 28b, 28c) to be registered in the vehicle unit 20 is described with reference to a sequence chart in FIG. 9. In this case, a well-known portion of DSRC protocol is omitted from the description for conciseness and brevity.

When the vehicle unit 20 receives a BST (Beacon Service Table) from the registration unit 50 after entering into a communication area of the registration unit 50 (S405), the vehicle unit 20 sends a response request (“SELECT CARD” in the drawing) for the IC card (S410). In this case, it is assumed that the IC card interface 25 of the vehicle unit 20 is impossible to communicate with the IC card (that is, it is assumed that the IC card is not in the proximity of the IC card interface 25).

If there is no response from the IC card before a predetermined time, the vehicle unit 20 sends to the registration unit 50 a VST (Vehicle Service Table) for informing the registration unit 50 of an absence of the IC card (S415).

When the vehicle unit 20 receives the BST again from the registration unit 50 after a predetermined interval (S420), the vehicle unit 20 sends the response request to the IC card (S430). If the IC card is able to communicate with the IC card interface 25 (if there is the IC card in a proximity of the IC card interface 25), a response to the vehicle unit 20 from the IC card (ATR in the figure) is sent (S435). Then, the vehicle unit 20 sends the VST to the registration unit 50 for informing the registration unit 50 of the presence of the IC card (S440).

Then, a mutual authentication is executed between the control unit 58 of the registration unit 50 and the vehicle unit 20 (S450), and the mutual authentication is executed between the card SAM of the registration unit 50 (one of the card SAMs 55, 56, 57 corresponding to the encryption method used for the present IC card) and the IC card (S455).

The card information read instruction is transmitted to the vehicle unit 20 from the control unit 58 of the registration unit 50 if the mutual authentication is normal (S460), and the vehicle unit 20 which received such instruction uses the IC card interface 25 to read the encrypted card information from the IC card (S465). In this case, the “card information” means a card number, an expiration date, name information, a card issuer number, a card type, the money balance, use history information and the like.

The vehicle unit 20 which has read the encrypted card information transmits the encrypted card information to the control unit 58 of the registration unit 50 (S470).

The control unit 58 of the registration unit 50 that received the encrypted card information passes the card information to one of the card SAMs corresponding to the card information (i.e., the card SAM that is capable of decrypting the card information) (S475). The card SAM which received the encrypted card information decrypts the encrypted card information, and passes the decrypted information to the control unit 58 (S480).

The control unit 58 which received the decrypted card information verifies the card information (S485). More practically, the control unit 58 verifies whether the decryption has been normal, whether the decrypted card information contains no discrepancy and the like. In this case, information may be retrieved from the information center 70 through the communication interface 54 for verification of the card information, or the card information may be transmitted to the information centre 70 for verification in the information centre 70.

If it is determined that the card information is normal, the control unit 58 of the registration unit 50 passes the decrypted card information to the road SAM 53 (S487). The road SAM 53 which received the decrypted card information encrypts the card information and passes the information to the control unit 58 (S488).

The control unit 58 which received the encrypted card information transmits the card information to the vehicle unit 20 (S490).

The vehicle unit 20 which received the encrypted card information stores the received information to the memory 26 (S495). Thereafter, whenever transmission of the encrypted card information is requested by the toll unit 60, the vehicle unit 20 transmits the card information that is stored in the memory 26 to the toll unit 60, instead of retrieving the card information from the IC card, without determining that a communication with the IC card is possible.

(2) Toll Collection Process

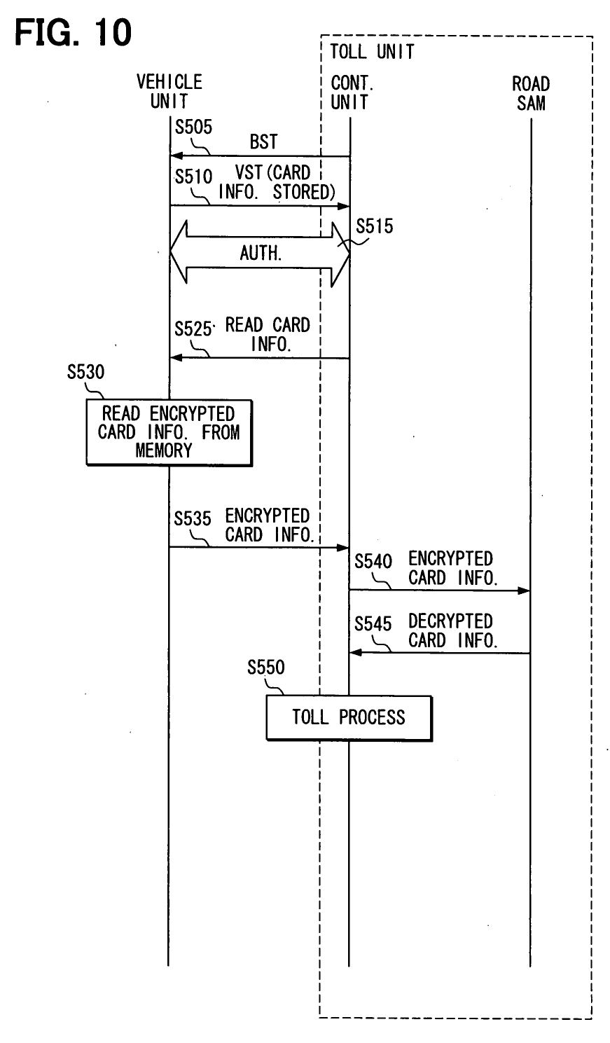

A process for collecting a toll by a communication between the vehicle unit 20 and the toll unit 60 is described next with reference to a sequence chart in FIG. 10. In this case, a well-known portion of DSRC protocol is omitted from the description for conciseness and brevity.

When the vehicle unit 20 receives the BST (Beacon Service Table) from the toll unit 60 after entering into a communication area (S505), the vehicle unit 20 determines whether the IC card information of the application corresponding to the toll unit 60 in the memory 26, and transmits the VST (Vehicle Service Table) to inform the toll unit 60 of the storage of the IC card information if the IC card information is stored in the toll unit 60 (S510).

Then, the mutual authentication is executed between the control unit 65 of toll unit 60 and the vehicle unit 20 (S515).

If the mutual authentication is normal, card information read instruction is transmitted to the vehicle unit 20 from the control unit 65 of toll unit 60 (S525). Then, the control unit 27 of the vehicle unit 20 reads the encrypted card information memorized in the memory 26 and corresponding to a specified application (S530). Then, the encrypted card information that has been read is transmitted to the toll unit 60 (S535).

The control unit 65 of the toll unit 60 that received the encrypted card information passes the card information to the road SAM (S540). The road SAM which received the encrypted card information passes the card information to the control unit 65 after decrypting the encrypted card information (S545).

The control unit 65 which received the decrypted card information performs a toll collection process (S550). More practically, the control unit 65 performs a payment process by transmitting the card information through the communication interface 64, or performs a process that reduces an amount of the money balance in the card information stored in the memory 26 of the vehicle unit 20.

(3) History Information Write Process

A history information write process is same as the process of the history information in the first embodiment stated above. That is, the history information write process in the second embodiment substitutes the process regarding the toll unit 40 with the process regarding the toll unit 60. Therefore, the description of the process is omitted.

### Effect of the Present Embodiment

The wireless communication system 15 has the same effect as the effect in the first embodiment. In addition, the wireless communication system 15 in the second embodiment has the following effects.

The wireless communication system 15 in the second embodiment is not required to have the card SAM to accommodate each of encryption methods used in the IC card, because of the above-described operation scheme.

### Third Embodiment

[Explanation of Configuration]

FIG. 11 is a block diagram showing a constitution of a wireless communication system 17 in the third embodiment. The wireless communication system 17 includes a vehicle unit 120 carried by a vehicle, a cellular phone 130 that can be carried by a user and the card center server 140 disposed in a credit card company. In this case, the vehicle unit 120 and the cellular phone 130 are communicable through DSRC, and a communication between the cellular phone 30 and the card center server 140 is provided through a wireless public communication network 150 of a cellular phone company or the like. In addition, though the cellular phone 130 and the wireless public communication network 150 are wirelessly connected, the card center server 140 and the wireless public communication network 150 are connected through wired communication.

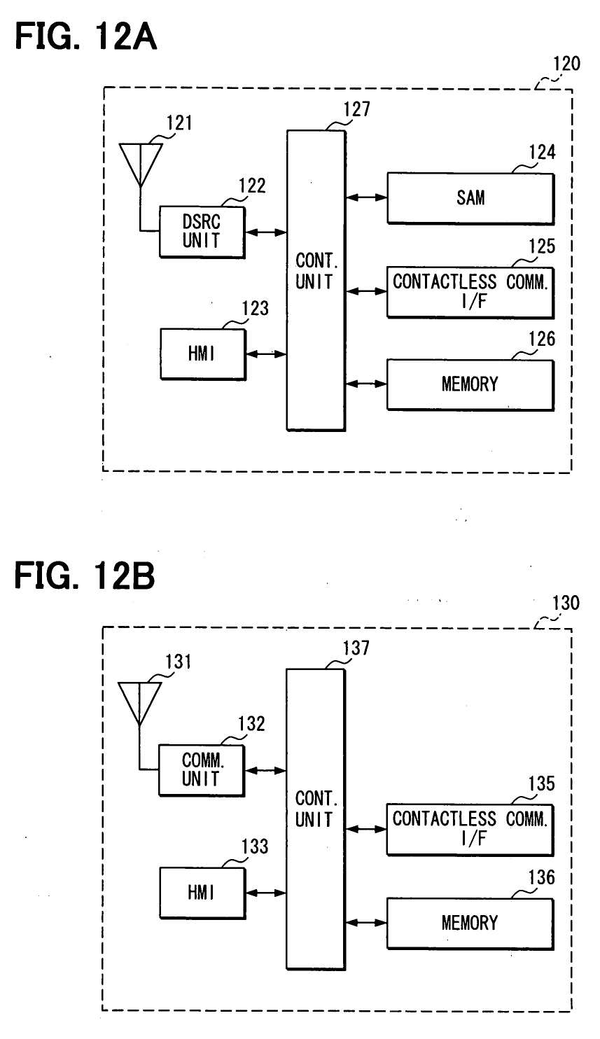

Next, the details of the vehicle unit 120 are explained by using a block diagram in FIG. 12A. The vehicle unit 120 equips a radio antenna 121, a DSRC unit 122, a HMI 123, a SAM 124, a contactless communication interface (I/F) 125, a memory 126 and a control unit 127.

The radio antenna 121 is used for Dedicated Short Range Communication (DSRC).

The DSRC unit 122 uses the radio antenna 121 for performing transmission and reception of information by DSRC.

The HMI 123 is a unit offering an interface (Human Machine Interface) for communication between a human being and a device. More practically, the interface consists of an operation button, LEDs and/or a speaker.

The SAM 124 performs encryption and decryption of information communication with the roadside unit which is not illustrated, and encryption/decryption of the vehicle unit information (a management number, a form registration number, the number of a vehicle and the like). In addition, encryption/decryption of a credit card ID for the vehicle unit mentioned later is also performed by the SAM 124.

A contactless communication interface 125 is an interface to perform a short distance radio communication in a contactless manner with the cellular phone 130. The contactless short distance radio communication may also be provided for a device such as a contactless type IC card through the interface 125 beside the communication with the cellular phone 130. Further, in this case, the communication may be provided through a contact type communication interface.

A memory 126 consists of a device that does not require a memory content retaining operation for storing various information (e.g., a flash memory).

The control unit 127 consists of a central processing unit (CPU), a ROM, a RAM, an I/O, and the like, and controls the DSRC unit 122, the HMI 123, the SAM 124, the contactless communication interface 125 and the memory 126 in a unified manner.

The details of the cellular phone 130 are explained by using a block diagram in FIG. 12B in the following. The cellular phone 130 equips a radio antenna 131, a public communication unit 132, a HMI 133, a SAM 134, a contactless communication interface (I/F) 135, a memory 136 and a control unit 137.

The radio antenna 131 is used for a wireless connection to the wireless public communication network 150.

The public communication unit 132 uses the radio antenna 131 for performing information transmission and reception through wireless communication (e.g., a CDMA communication or the like).

The HMI 133 is a unit offering an interface (Human Machine Interface) for communication between a human being and a device. More practically, the interface consists of an operation button, a liquid crystal display, a speaker, a microphone and the like.

The contactless communication interface 135 is an interface to perform the vehicle unit 120. The communication through the interface 135 may also be provided for a device that uses the contactless short distance wireless communication beside the communication with the vehicle device 120. Further, in this case, the communication may also be provided through a contact type communication interface.

The memory unit 136 consists of a device that does not require a memory content retaining operation for storing various information (e.g., a flash memory). In this case, the memory 136 stores a credit ID for a cellular phone (i.e., an ID that is issued by a credit company for use in a payment).

The control unit 137 consists of a central processing unit (CPU), a ROM, a RAM, an I/O, and controls the public communication unit 132, the HMI 133, the contactless communication interface 135 and the memory 136 in a unified manner.

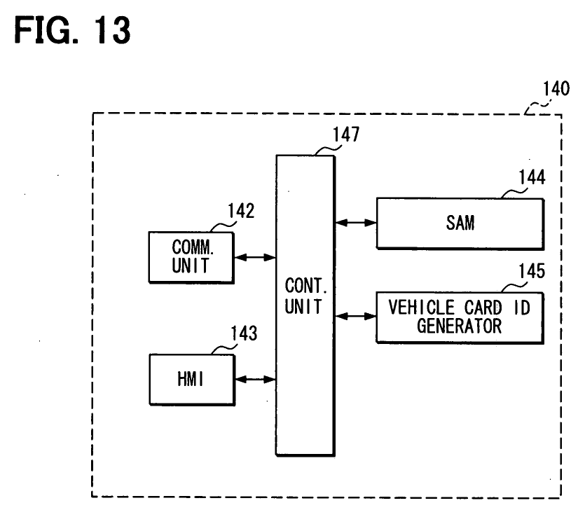

The details of the card center server 140 are explained by using a block diagram in FIG. 13 in the following.

The card center server 140 equips a public communication unit 142, an HMI 143, the SAM 144 and a vehicle card ID generator 145.

The public communication unit 142 uses the wireless public communication network 150 to perform communication with the cellular phone 130.

The HMI 143 is a unit offering an interface (Human Machine Interface) for communication between a human being and a device. More practically, the interface consists of a keyboard, a mouse, a display and the like.

The SAM 144 is a unit having the same function as the SAM 124 of the vehicle unit 120, and performs encryption/decrypting of communication information when the server 140 communicates with the vehicle unit 120 through the wireless public communication network 150 and the cellular phone 130. Though the card center server 140 has the SAM 144 in the present embodiment, a different server may have the function that is equivalent to the SAM 144, and the function on the different server may be employed for encryption/decryption.

The vehicle card ID generator 145 generates a credit ID for a vehicle unit (a vehicle card ID hereinafter) based on a predetermined ID. The credit ID for a vehicle unit is the same kind of a credit ID for a cellular phone, and the credit ID for a vehicle unit is intended for storage in the vehicle unit. The credit ID for a vehicle unit is retrieved on demand for a payment process.

[Explanation of Operation]

Operation of the wireless communication system 17 is explained in the following.

(1) Vehicle Card ID Registration Process (Whole Process).

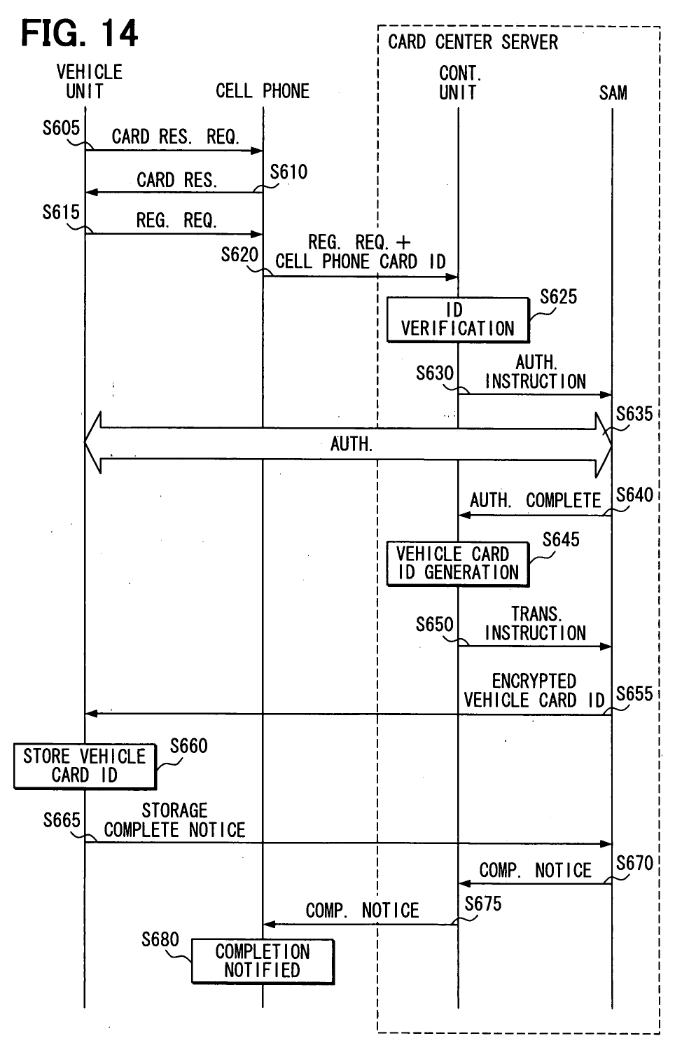

A whole process for registering a vehicle card ID to vehicle unit 120 is explained by using a sequence chart in FIG. 14.

When a power supply for the vehicle unit 120 is turned on, the contactless communication interface 125 generates a card response request signal at a predetermined interval (S605). The cellular phone 130 which received the response request responds to the response request with a response that indicates the presence of the card (S610). Then, the vehicle unit 120 transmits a registration request to the cellular phone 130 (S615).

The cellular phone 130 which received the registration request transmits to the card center server 140 a registration request and the cellular phone card ID stored in the memory 126 (S620).

The control unit 147 of the card center server 140 which received the registration request and the cellular phone card ID performs verification of the cellular phone card ID (S625). More practically, the control unit 147 verifies authenticity of the cellular phone card ID, determines whether an issuance of the vehicle card ID should be performed, and identifies a credit card holder corresponding to the cellular phone card ID.

When the control unit 147 of the card center server 140 finishes verification of the cellular phone card ID, the control unit 147 transmits an instruction to the SAM 144 for performing a mutual authentication with the vehicle unit 120 (S630).

The SAM 144 which received the instruction of the mutual authentication performs the mutual authentication with the vehicle unit 120 (i.e., with the SAM 124 of the vehicle unit 120) after requesting the mutual authentication to the vehicle unit 120. The mutual authentication may be performed by various methods such as a random number generation method. When the mutual authentication is successful, a communication channel for the encrypted information is established between the SAM 144 of the card center server 140 and the SAM 124 of the vehicle unit 120, and the established channel is used for the subsequent communication between the vehicle unit 120 and the card center server 140. In this case, the cellular phone 130 transmits the encrypted information that is received by the public communication unit 132 from the card center server 140 after making the encrypted information to be output as it is from the contactless communication interface 135 for transmission to the vehicle unit 120, and transmits the encrypted information received by the contactless communication interface 135 from the vehicle unit 120 after passing the encrypted information to the public communication unit 132 as it is for transmission to the card center server 140 in the course of a transparent communication process.

If the mutual authentication was successful, the SAM 144 of the card center server 140 transmits a notice that the mutual authentication is complete to the control unit 147 (S640).

The control unit 147 of the card center server 140 which received the completion notice of the mutual authentication generates the vehicle card ID for a the credit card holder identified in step S625 (S645).

The control unit 147 of the card center server 140 instructs the SAM 144 to transmit the generated vehicle card ID to the vehicle unit 120 after encryption (S650).

The SAM 144 of the card center server 140 which received a transmission instruction encrypts the vehicle card ID, and transmits the encrypted vehicle card ID to the vehicle unit 120 through the cellular phone 130 after outputting the encrypted vehicle card ID from the public communication unit 142 to the public communication network 150 (S655).

The vehicle unit 120 which received the vehicle card ID decrypts the received card ID by using the SAM 124 for storage in the memory 126 (S660). Then, the vehicle unit 120 transmits a completion notice that indicates the completion of storage to the card center server 140 when storage of the card ID is completed (S665).

The SAM 144 of the card center server 140 which received the completion notice decrypts the completion notice and passes the notice to the control unit 147 (S670). The control unit 147 which received the completion notice relays the completion notice to the cellular phone 130 (S675).

The cellular phone 130 which received the completion notice notifies the user of the cellular phone 130 about the completion from the HMI 133 (S680). For example, a message “Vehicle card ID registration completed” is displayed on a display unit.

In a subsequent process, when the vehicle unit 120 receives a vehicle card ID retrieval request from a roadside unit or the like, the vehicle card ID is encrypted by the SAM 124 to be transmitted to the roadside unit through the DSRC unit 122 according to the above-described registration process for storing the vehicle card ID in the vehicle unit 120. In this case, because the transmission process is identical with the toll collection process in the first and second embodiments, description of the transmission process is omitted.

(2) Vehicle Card ID Registration Process (Vehicle Unit Side)

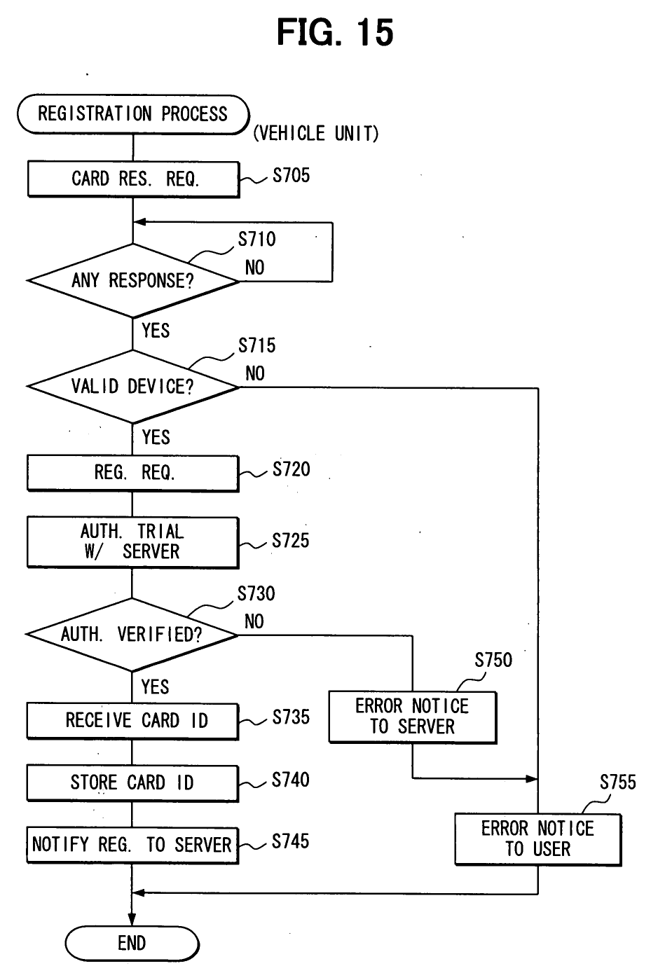

The details of a process performed by the control unit 127 of the vehicle unit 120 in the Vehicle card ID registration process (Whole process) stated above are described with reference to a flowchart in FIG. 15. In this case, the vehicle card ID registration process (Vehicle unit side) is initiated when an electric power is supplied to the vehicle unit 120.

The control unit 127 of the vehicle unit 120 transmits a card response request when the vehicle card ID registration process (Vehicle unit side) is started through the contactless communication interface 125 (S705). Then, whether the contactless communication interface 125 has any response in a predetermined period (e.g., within 10 seconds) is determined (S710). When a response is detected (S710:YES), the process proceeds to step S715. When a response is not detected (S710:NO), the process remains in the present step until the response is detected.

The control unit 127 determines whether the device which has responded to the request can be utilized for the vehicle card ID registration in step S715 that comes after a determination that the response is detected. When the device is determined to be utilized (S715:YES), the process proceeds to step S720. When the device is determined not to be utilized (S715:NO), the process proceeds to step S755.

The control unit 127 transmits the registration request to the device that has responded (i.e., to the cellular phone 130).

Then, a mutual authentication with the card center server 140 is performed upon having a request from the card center server 140 (S725). More practically, the SAM 124 of the vehicle unit 120 and the SAM 144 of the card center server 140 perform the mutual authentication with each other.

Then, it is determined whether the mutual authentication is successful (S730). When the mutual authentication is successful (S730:YES), the process proceeds to step S735. When the mutual authentication is not successful (S730:NO), the process proceeds to step S750. In this case, when the mutual authentication is successful, a channel for the encrypted information to be exchanged between the SAM 144 of the card center server 140 and the SAM 124 of the vehicle unit 120 is established, and the channel is used for communication between the vehicle unit 120 and the card center server 140 thereafter.

The control unit 127 receives the vehicle card ID in step S735 that comes after a determination that the mutual authentication is successful. That is, the control unit 127 receives the vehicle card ID transmitted from the card center server through the cellular phone 130.

The control unit 127 stores (i.e., registers) the vehicle card ID in the memory 126 upon receiving it. Then, the control unit 127 notifies the card center server 140 of the completion of the registration via the cellular phone 130 (S745). Then, the present process (Vehicle card ID registration process (Vehicle unit side)) is concluded.

On the other hand, the control unit 127 notifies the card center server 140 of an error via cellular phone 130 in step S750 that comes after a determination that the mutual authentication is not successful. Then, the process proceeds to step S755.

In step S755, the error is notified to a user of the vehicle unit 120. More practically, for example, an LED is lit for indicating that the registration of vehicle card ID to the vehicle unit has failed with an accompanying guidance message output from a speaker. Then, the present process (Vehicle card ID registration process (Vehicle unit side)) is concluded.

(3) Vehicle Card ID Registration Process (Card Center Server Side)

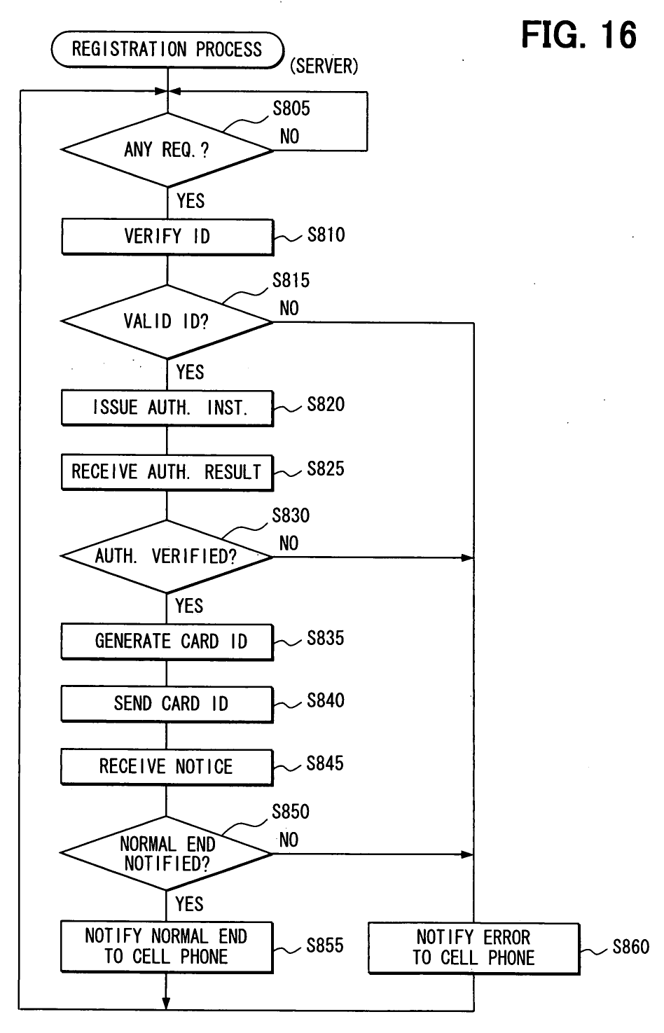

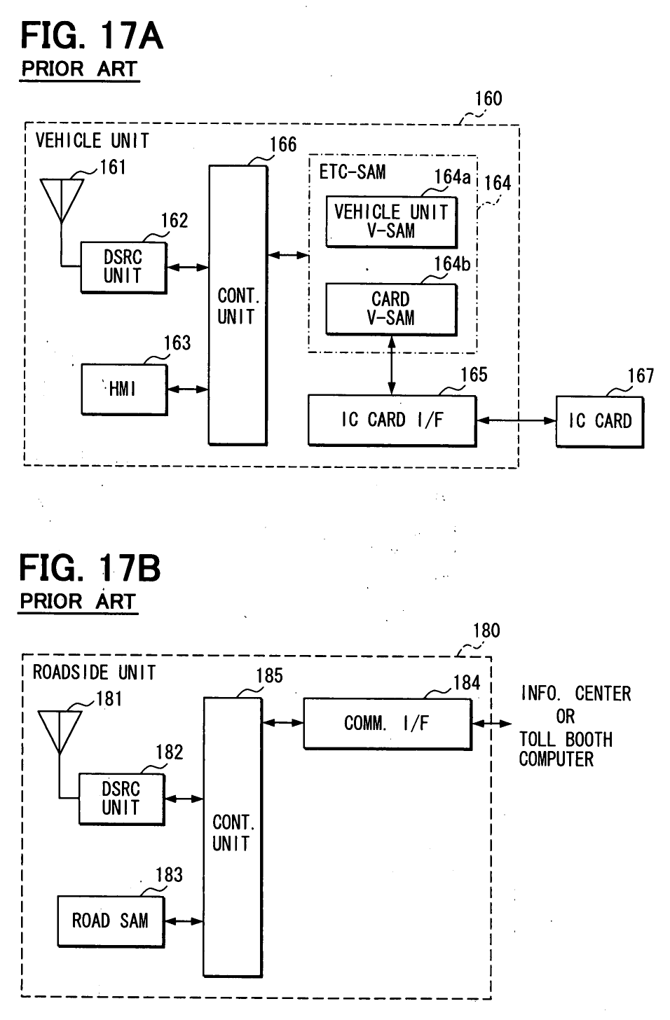

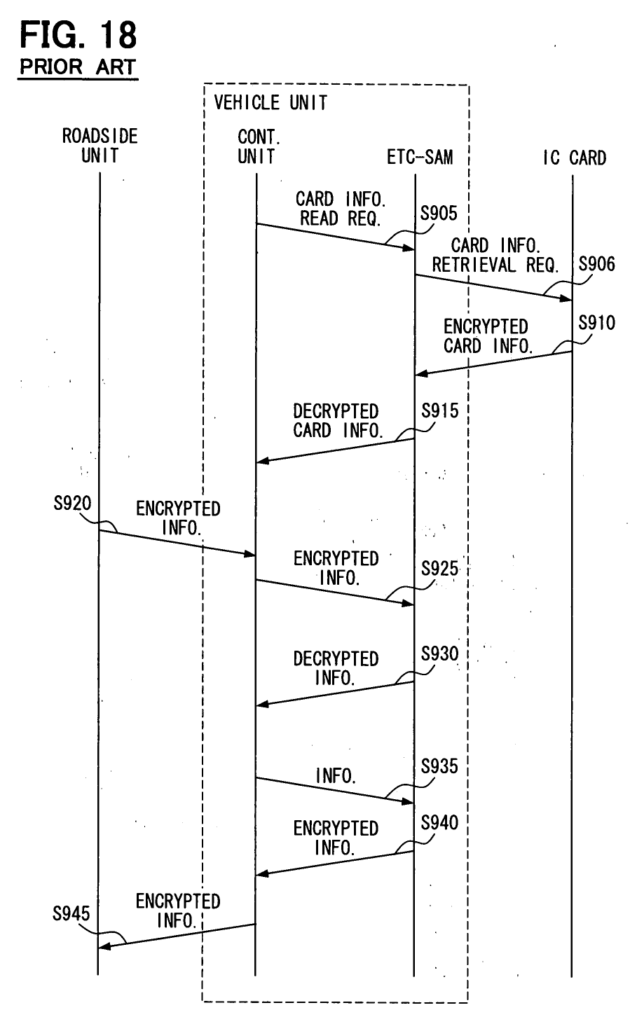

The details of a process performed by the control unit 147 of the card center server 140 in the Vehicle card ID registration process (Whole process) stated above are described with reference to a flowchart in FIG. 16. In this case, the vehicle card ID registration process (Card center server side) is initiated when an electric power is supplied to the card center server 140.

When the vehicle card ID registration process (Card center server side) in the control unit 140 of the card center server control unit 147 is started, the control unit 147 determines whether any request of registration from the vehicle unit 120 is received (S805). When the registration request is determined to be received (S805:YES), the process proceeds to step S810. When the request is determined not to be received (S805:NO), the process remains at the present step until it receives the request.

In step S810 that comes after a determination that the registration request is received, the cellular phone card ID is verified. More practically, the control unit 147 verifies authenticity of the cellular phone card ID, determines whether an issuance of the vehicle card ID should be performed, and identifies a credit card holder corresponding to the cellular phone card ID.

Then, it is determined whether a verification result of the cellular phone card ID is correct (S815). When the card ID is determined to be correct (S815:YES), the process proceeds to step S820. When the card ID is determined not to be correct (S815:NO), the process proceeds to step S860.

In step S820 that comes after a determination that the cellular phone card ID is correct, a mutual authentication instruction is issued to the SAM 144 for performing the authentication with the vehicle unit 120. The SAM 144 which received an instruction to perform the mutual authentication performs the mutual authentication after requesting the mutual authentication to the vehicle unit 120 (i.e., the SAM 124 of the vehicle unit 120). Then, the SAM 144 notifies the control unit 147 of the completion of the mutual authentication when the mutual authentication is successful.

In step S830, the process branches according to the result of the mutual authentication. That is, whether the mutual authentication is successful or not affects the process. When the mutual authentication is successful (S830:YES), the process proceeds to step S835. When the process is not successful (S830:NO), the process proceeds to step S860.

In step S835 that comes after a determination that the mutual authentication is successful, the vehicle card ID generator 145 is instructed to generate a vehicle card ID. Then, the generated vehicle card ID is encrypted by the SAM 144 to be transmitted to the vehicle unit 120 through the cellular phone 130 (S840).

Then, a notice from the vehicle unit 120 is received (S845). The notice is either of a normal end notice which indicates that the vehicle unit 120 has received the vehicle card ID and its registration has been complete (i.e., the notice in step S745 described above), or an error notice which indicates that the vehicle unit 120 has received the vehicle card ID and its registration has not been successful (i.e., the notice in step S750 described above).

Then, in step S850, the process determines whether the notice received in step S845 is the normal end notice. When the notice is determined to be the normal end notice (S850:YES), the process proceeds to step S855. When the notice is determined to be the error notice (S850:NO), the process proceeds to step S860.

In step S855 which comes after a determination that the notice is the normal end notice, the process notifies the cellular phone 130 of the normal end of the process. The notice of the normal end is intended for displaying the normal end of the process on a display of the cellular phone 130. Then, the present process (Vehicle card ID registration process (Card center server side)) concludes itself.

In step S860, the process notifies the cellular phone 130 of the error in the process. The notice of the error is intended for displaying the error in the process on the display of the cellular phone 130. Then, the present process (Vehicle card ID registration process (Card center server side)) concludes itself.

### Effect of the Present Embodiment

The wireless communication system 17 in the third embodiment can store the vehicle card ID to the memory 126 without any specific device (e.g., the registration unit or the like), and can send the ID to the vehicle unit 120 only when the issuance of the ID is approved on the card center server side. Therefore, the usability by the user of the credit card is improved without compromising the reliability of the credit card system.

Further, the card ID is encrypted in the card center server 140 and decrypted in the vehicle unit 120, thereby making it difficult to eavesdrop the card ID in the course of communication.

Furthermore, the vehicle unit 120 and the server 140 perform the mutual authentication prior to the communication, thereby effectively preventing the fraud such as a spoofing or the like.

Furthermore, the registration of the ID in the vehicle unit 120 is sent to the server 140 through the cellular phone 130, which is then redirected to be returned the cellular phone 130. In this manner, the registration of the ID in the vehicle unit 120 as well as the registration notice to the card center server 140 are transmitted and notified to the user of the cellular phone 130. Therefore, the user of the credit card can have an improved sense of security.

### Other Embodiments

Although the present invention has been fully described in connection with the preferred embodiment thereof with reference to the accompanying drawings, it is to be noted that various changes and modifications will become apparent to those skilled in the art.

(1) In the first embodiment described above, there are two types of the roadside unit, that is, the registration unit 30 and the toll unit 40 in the wireless communication system. However, the roadside unit having the function of both types in one body may be used to produce the same effect. The system in the second embodiment may have the same modification.

(2) In the first embodiment described above, the information is first encrypted by the SAM in the registration unit 30 to be stored in the IC card. However, the information retrieved from the memory 26 of the vehicle unit 20 may be stored in the IC card without encryption depending on the type of the information.

In this manner, the registration unit 30 may be omitted from an information writing process to write the information in the IC card, thereby allowing the information to be stored in the IC card when the communication to the registration unit 30 is not available. The same advantage may apply to the second embodiment.

(3) The wireless communication system 17 in the third embodiment stores the ID in the memory 136 of the cellular phone 130, and sends the ID to the server 140. However, the ID sent from the memory 136 may be substituted with an input of ID/password, other specific codes or the like from operation buttons on the cellular phone 130, and the server 140 may verify the inputted ID/password on the server side. In this manner, the same advantage is achieved as the third embodiment.

Such changes and modifications are to be understood as being within the scope of the present invention as defined by the appended claims.

What is claimed is:

1. A wireless communication system having a vehicle unit, a first roadside unit and a second roadside unit,
the vehicle unit comprising:
a vehicle side wireless communication unit that processes a wireless communication signal;
an interface unit that retrieves encrypted information from an external memory medium that is used for storing the encrypted information;
a storage that stores information; and
a vehicle side controller that controls in a unified manner the vehicle side wireless communication unit, the interface unit and the storage,
the first roadside unit comprising:
a first wireless communication unit that processes the wireless communication signal;
a first security unit that decrypts the encrypted information; and
a first controller that controls in a unified manner the first wireless communication unit and the first security unit, and
the second roadside unit comprising:
a second wireless communication unit that processes the wireless communication signal;
a second security unit that decrypts the encrypted information; and
a second controller that controls in a unified manner the second wireless communication unit and the second security unit,
wherein the vehicle side controller transmits the encrypted information that is retrieved from the external memory medium with the interface unit to the first roadside unit by way of the vehicle side wireless communication unit,
the first controller transmits the encrypted information that is received from the vehicle unit through the first wireless communication unit back to the vehicle unit with the first wireless communication unit after verifying authenticity of a content of the encrypted information by decrypting the encrypted information with the first security unit,
the vehicle side controller stores in the storage the encrypted information that is received from the first roadside unit through the vehicle side wireless communication unit, and thereafter transmits the encrypted information that is stored in the storage through the vehicle side wireless communication unit to the second roadside unit upon having a transmission request for the encrypted information stored in the external memory medium from the second roadside unit, and
the second controller puts the encrypted information that is received by sending a request to the vehicle unit for use by a predetermined application after decrypting the encrypted information with the second security unit.

2. The wireless communication system of claim 1,
wherein the first roadside unit has plural first security units for accommodating each of plural encryption types that are used in the external memory medium, and
wherein the second roadside unit has plural second security units for accommodating each of plural encryption types that are used in the external memory medium.

3. The wireless communication system of claim 1,
wherein the first security unit is capable of encrypting information,
the interface unit is capable of writing the information on the external memory medium,
the vehicle side controller transmits the information through the vehicle side wireless communication unit to the first roadside unit when the information is stored in the external memory medium,
the first roadside unit transmits encrypted information to the vehicle unit through the first wireless communication unit after encrypting the information that is received from the vehicle unit through the first wireless communication unit by using the first security unit, and
the vehicle side controller writes on the external memory medium through the interface unit the encrypted information received from the first roadside unit through the vehicle side wireless communication unit.

4. A wireless communication system having a vehicle unit, a first roadside unit and a second roadside unit,
the vehicle unit comprising:
a vehicle side wireless communication unit that processes a wireless communication signal;
an interface unit that retrieves encrypted information from an external memory medium that is used for storing the encrypted information;
a storage that stores information; and
a vehicle side controller that controls in a unified manner the vehicle side wireless communication unit, the interface unit and the storage,
the first roadside unit comprising:
a first wireless communication unit that processes the wireless communication signal;
a first security unit having an encryptor that encrypts information and a decryptor that decrypts information; and
a first controller that controls in a unified manner the first wireless communication unit and the first security unit, and
the second roadside unit comprising:
a second wireless communication unit that processes the wireless communication signal;
a second security unit that decrypts the encrypted information; and
a second controller that controls in a unified manner the second wireless communication unit and the second security unit,
wherein the vehicle side controller transmits the encrypted information that is retrieved from the external memory medium with the interface unit to the first roadside unit by way of the vehicle side wireless communication unit,
the first controller transmits the encrypted information that is received from the vehicle unit through the first wireless communication unit back to the vehicle unit with the first wireless communication unit after verifying authenticity of a content of the encrypted information by decrypting the encrypted information and re-encrypting the decrypted information with the first security unit,
the vehicle side controller stores in the storage the encrypted information that is received from the first roadside unit through the vehicle side wireless communication unit, and thereafter transmits through the vehicle side wireless communication unit to the second roadside unit the encrypted information that is stored in the storage upon having a transmission request for the encrypted information stored in the external memory medium from the second roadside unit, and
the second controller puts the encrypted information that is received by sending a request to the vehicle unit for use by a predetermined application after decrypting the encrypted information with the second security unit.

5. The wireless communication system of claim 4,
wherein the first security unit has plural decryptors for accommodating each of plural encryption types that are used in the external memory medium.

6. The wireless communication system of claim 4,
wherein the interface unit is capable of writing information on the external memory medium,
the vehicle side controller transmits the information to the first roadside unit through the vehicle side wireless communication unit when the information is stored in the external memory medium,
the first controller transmits through the first wireless communication unit to the vehicle unit the information that is received from the vehicle unit through the first wireless communication unit after encrypting the information with the first security unit, and
the vehicle side controller writes on the external memory medium with the interface unit the encrypted information that is received from the first roadside unit through the vehicle side communication unit.

7. A vehicle unit comprising:
a vehicle side wireless communication unit that processes a wireless communication signal;
an interface unit that retrieves encrypted information from an external memory medium that is used for storing the encrypted information;
a storage that stores information; and
a vehicle side controller that controls in a unified manner the vehicle side wireless communication unit, the interface unit and the storage,
wherein the vehicle side controller transmits the encrypted information that is retrieved from the external memory medium with the interface unit to a first roadside unit by way of the vehicle side wireless communication unit, and
the vehicle side controller stores the encrypted information in the storage after verifying and transmitting the encrypted information from first roadside unit, and thereafter transmits through the vehicle side wireless communication unit to a second roadside unit the encrypted information that is stored in the storage upon having a transmission request from the second roadside unit for the encrypted information stored in the external memory medium.

8. The vehicle unit of claim 7,
wherein the interface unit is capable of writing the information on the external memory medium, and
the vehicle side controller transmits the information to the first roadside unit through the vehicle side wireless communication unit, receives through the vehicle side wireless communication unit the encrypted information that is encrypted in the first roadside unit, and writes through the interface unit on the external memory medium the encrypted information.

9. A first roadside unit comprising:
a first wireless communication unit that processes the wireless communication signal;
a first security unit that decrypts the encrypted information; and
a first controller that controls in a unified manner the first wireless communication unit and the first security unit,
wherein the first controller transmits the encrypted information through the first wireless communication unit to the vehicle unit after decrypting the encrypted information for authenticity verification by using the first security unit when the encrypted information is received from the vehicle unit with the first wireless communication unit.

10. The first roadside unit of claim 9,
wherein plural first security units are disposed in correspondence to each of encryption types that are used in the external memory medium for use in the vehicle unit.

11. The first roadside unit of claim 9,
wherein the first security unit is capable of encrypting the information,
the first controller encrypts by using the first security unit the information that is received through the first wireless communication unit from the vehicle unit to be stored in the external memory medium used in the vehicle unit, and transmits the encrypted information through the first wireless communication unit to the vehicle unit.

12. A first roadside unit comprising:
a first wireless communication unit that processes the wireless communication signal;
a first security unit having an encryptor that encrypts information and a decryptor that decrypts information; and
a first controller that controls in a unified manner the first wireless communication unit and the first security unit,
wherein the first controller transmits the encrypted information through the first wireless communication unit to the vehicle unit after decrypting the encrypted information for authenticity verification and re-encrypting the decrypted information by using the first security unit when the encrypted information is received from the vehicle unit with the first wireless communication unit.

13. The first roadside unit of claim 12,
wherein the first security unit has plural decryptors for accommodating each of plural encryption types that are used in the external memory medium.

14. The first roadside unit of claim 12,
the first controller encrypts by using the first security unit the information that is received through the first wireless communication unit from the vehicle unit to be stored in the external memory medium used in the vehicle unit, and transmits the encrypted information through the first wireless communication unit to the vehicle unit.

15. A second roadside unit comprising:
a second wireless communication unit that processes the wireless communication signal;
a second security unit that decrypts the encrypted information; and
a second controller that controls in a unified manner the second wireless communication unit and the second security unit,
wherein the second controller decrypts the encrypted information that is received after sending a request to the vehicle unit by using the second security unit for use in a predetermined application.

16. The first roadside unit of claim 15,
wherein plural second security units are disposed in correspondence to each of plural encryption types that are used in the external memory medium for use in the vehicle unit.

17. A wireless communication system having a vehicle unit, a portable terminal and a server,
the vehicle unit comprising:
a first vehicle communication unit that communicates with a roadside unit;
a second vehicle communication unit that communicates with the portable terminal;
a vehicle storage that stores information; and
a vehicle controller that controls the first vehicle communication unit, the second vehicle communication unit and the vehicle storage in a unified manner,
the portable terminal comprising:
a first portable communication unit that communicates with the server through a wireless public network;
a second portable communication unit that communicates with the vehicle unit; and
a portable controller that controls the first portable communication unit and the second portable communication unit in a unified manner, and
the server comprising:
a server communication unit that communicates with the portable terminal through the wireless public network; and
a server controller that controls the server communication unit in a unified manner,
wherein the portable controller transmits first identification information to the server through the first portable communication unit,
the server controller checks authenticity of the first identification information received by the server communication unit, generates second identification information that corresponds to the first identification information upon verifying authenticity of the first identification information and transmits the second information to the portable terminal through the server communication unit,
the portable controller transmits the second identification information received by the first portable communication unit to the vehicle unit through the second portable communication unit, and
the vehicle controller stores the second identification information on the vehicle storage and transmits the second identification information stored on the vehicle storage to the roadside unit through the first vehicle communication unit upon having a request for the second identification information from the roadside unit when the vehicle controller receives the second identification information from the portable terminal with second vehicle communication unit.

18. The wireless communication system of claim 17,
wherein the vehicle unit further comprises a vehicle security unit that encrypts and decrypts information,
the server further comprises a server security unit that encrypts and decrypts information,
the server controller transmits the second identification information encrypted by the server security unit to the portable terminal,
the vehicle controller stores the second identification information received from the portable terminal on the vehicle storage after decryption by the vehicle security unit, and transmits the second identification information to the roadside unit after encryption by the vehicle security unit.

19. The wireless communication system of claim 18,
wherein the server controller and the vehicle controller authenticate with each other respectively by using the server security unit and the vehicle security unit before the server controller transmits the second identification information.

20. The wireless communication system of claim 17,
wherein the portable terminal further comprises a notification unit that provide a notice,
the vehicle controller notifies the server of storage of the second identification information through the portable terminal,
the server controller transmits a notice of storage to the portable terminal upon having the notice of storage from the vehicle unit through the portable terminal, and
the portable controller controls the notification unit to provide the notice of storage upon having the notice of storage from the server.

21. A vehicle unit comprising:
a first vehicle communication unit that communicates with a roadside unit;
a second vehicle communication unit that communicates with a portable terminal;
a vehicle storage that stores information; and
a vehicle controller that controls the first vehicle communication unit, the second vehicle communication unit and the vehicle storage in a unified manner,
wherein the vehicle controller stores the second identification information on the vehicle storage when the vehicle controller receives the second identification information from the portable terminal through the second vehicle communication unit, and thereafter transmits the second identification information stored in the vehicle storage to the roadside unit through the first vehicle communication unit upon having a request for the second identification information from the roadside unit.

22. The vehicle unit of claim 21,
wherein the vehicle unit further comprises the vehicle security unit that encrypts and decrypts information, and
the vehicle controller stores the second identification information received from the portable terminal in an encrypted form after decryption by the vehicle security unit, and transmits the second identification information to the roadside unit after encryption by vehicle security unit.

23. The vehicle unit of claim 21
wherein the vehicle unit further comprises a notification unit that provides a notice, and
the vehicle controller provide a notice of storage to the server through the portable terminal after storing the second identification information.

24. A server comprising:
a server communication unit that communicates with a portable terminal through a wireless public network; and
a server controller that controls the server communication unit in a unified manner,
wherein the server controller receives a first identification information from the portable terminal through the server communication unit, checks authenticity of the first identification information, generates the second identification information that corresponds to the first identification information upon verifying authenticity of the first identification information and transmits the second identification information to the portable terminal through the server communication unit after.

25. The server of claim 24,
wherein the sever further comprises a server security unit that encrypts and decrypts information, and
the server controller transmits to the portable terminal the second identification information that is encrypted by the server security unit.

26. The server of claim 24,
wherein the server controller transmits a notice to the portable terminal when the server controller receives the notice from the vehicle unit through the portable terminal.
